(19) United States
(12) Patent Application Publication
(10) Pub. No.: US 2021/0191152 A1
(43) Pub. Date: Jun. 24, 2021

(54) Optic Retainer Hooks

(71) Applicants: Leon Helfet, Camarillo, CA (US); Todd James Hannon, Oxnard, CA (US)

(72) Inventors: Leon Helfet, Camarillo, CA (US); Todd James Hannon, Oxnard, CA (US)

(21) Appl. No.: 16/725,973

(22) Filed: Dec. 23, 2019

(51) Int. Cl. G02C 5/14

(52) U.S. Cl. CPC G02C 5/143; G02C 3/003

(57) ABSTRACT

The invention allows the wearer to easily retain and locate the optics in various positions on the bridge of the nose to enable viewing through different optical field depths as in the case of tri-focals and other progressive lenses. Another benefit of soft hooks is the prevention of the glasses being dislodged due to moisture such as sweat, and sudden movement such as in sports or working activities. The design focusses on the invention being able to apply to eyeglass arms of various shapes and thicknesses including readers, sunglasses and fashionable straight arms. A unique feature is the simple attachment of the invention as a result of the voids between entry and exit points for the prevention of a ‘caterpillar’ effect. The design facilitates robust positional locational stability on the frame arms, but still allows adjustment for varying positioning needs.

### BACKGROUND OF THE INVENTION

Spectacles, goggles, safety glasses and sunglasses are renowned for slipping and sometimes falling off the face. Many different designs and accessories have been available to keep them in place. Different curved and non-smooth designs have been created to improve their retention properties, many with limited customization or even effective holding-in-place abilities.

Modern glasses styles have emerged with fairly straight shaped side members, especially plastic molded sunglasses, where retention on the face appears to have not been considered in deference to stylishness.

Many accessory means for preventing spectacles and sunglasses from slipping or falling off have been developed and sold, from end-fitting laces to rubber and silicone protruding bumps that purport to stabilize and keep glasses in place.

One of the more versatile methods of prior art has been the molded hook that slides on the end of the frame arm. This product offers the potential to engage the ear effectively, is soft and comfortable. The existing thermoform hooks adopt a one-size-fits-all school of thought, where the engaging channel for attachment is parallel and continuous, with no allowance for various width arms and ends. When a tight fit, the molded material is difficult to grip, squeezing to push on the arm makes it more difficult to slide, and will buckle with the necessary pressure required to squeeze into position. Indeed, even when forced into position, the propensity to fail early in service due to being stretched beyond their elastic limit is a problem with existing designs. By the very design, they are difficult or impossible to reposition after being in place for a length of time.

### SUMMARY OF THE INVENTION

This invention, a silicone arm hook, which comes in 2 sizes, has features to obviate the failings of existing art. The leading edge is designed as a feature to facilitate improved pushing onto the end without undue squeezing. Being a raised and square shape, it allows more axial pressure in the direction of attachment, and less squeezing to get a grip while pushing into place. A relief design below this edge allows a space where the channel is not continuous, but has a complex less compressive pressure zone, before the intruding arm end engages the back end of the channel. Both the leading edge and back end are molded in a rectangular internal profile so as to match the usual arm shape, and prevent undesirable rotation of the hook. A secondary component of the new design is an elastic wide compression band that is applied over the relief channel below the leading edge. This provides a greater stretch capability for a range of arm sizes without stressing the parallel channel in existing designs. It also adds more pressure-point gripping due to the convex profile of the relief channel.

All the art described above contribute to the hook fitting a greater range of arm sizes and widths while still being able to be adjustable for comfortable engagement around the ear and securing to the head in the best position of use.

### BRIEF DESCRIPTION OF THE DRAWINGS

FIG. 1 is a schematic perspective view illustrating the outer appearance of a pair of glasses with an optic retainer hook positioned on the arm of a glasses frame as worn behind the ear

FIG. 2 is a schematic perspective view illustrating an optic retainer hook as fitted to the arm end of a glasses frame

FIG. 3 is a schematic perspective view illustrating the parts comprising an assembled optic retainer hook, and

FIG. 4 is a schematic perspective view illustrating the design features of the optic retainer hook assembly.

### DETAILED DESCRIPTION OF THE INVENTION

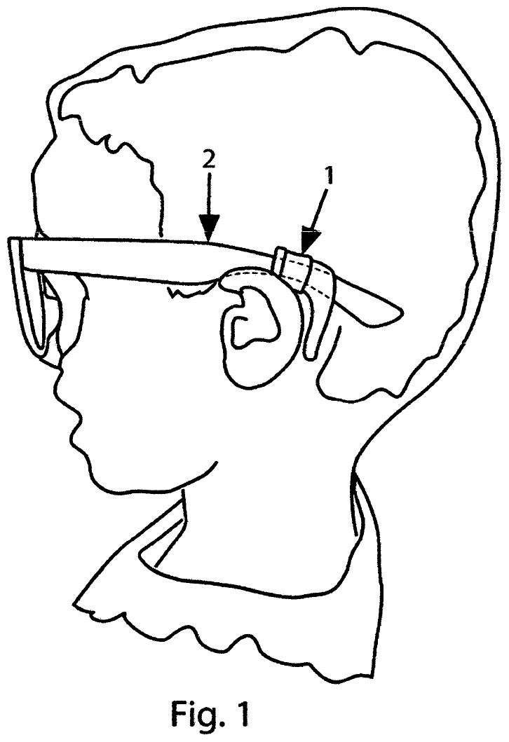

FIG. 1 is a perspective view showing the arm 2 of a typical pair of optics as worn on the face, showing an optic retainer hook 1 loosely in position behind the ear. This view as shown does not reflect the hook as it would function in use, as it would be obscured behind the ear if located in a position where it would function as designed.

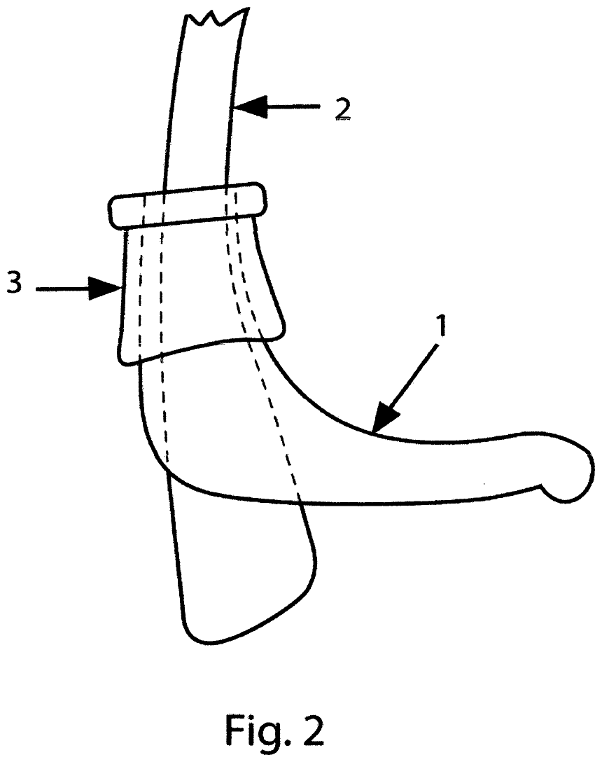

FIG. 2 shows the hidden lines of an assembled optic retainer hook 1 in position and engaged on a frame arm 2. The compressive band 3 squeezes the walls of the main molding 1 into the opening 6 to hold the hook firmly in the desired position on the frame arm.

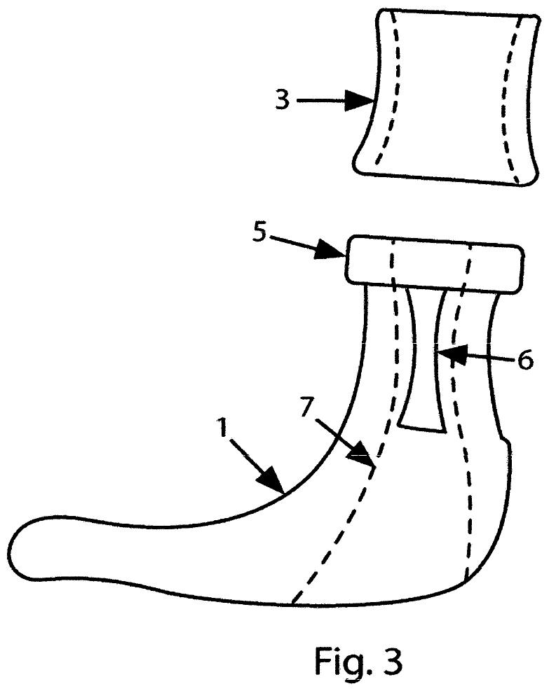

FIG. 3 illustrates an unassembled view of the compression band 3 and the naked hook body showing the concave walls and opening 6 of the gripping area of the main molding 1. This concave profile 6 when compressed onto a frame arm 2, creates a ‘point load’ that grips to maintain location without bonding over the full length of the inner channel 7 which is shown as dotted.

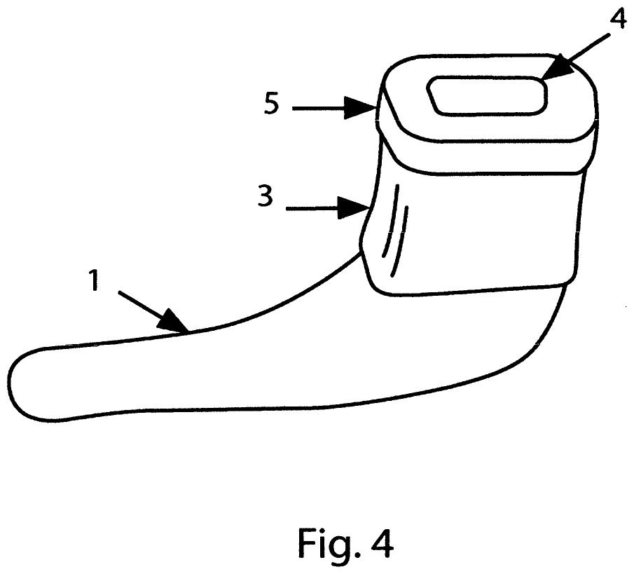

FIG. 4 is a view of the top leading edge 5 that is bulky enough to be able to be gripped and pushed onto the arm 2, keep the compressive band 3 in place, and elastic enough to provide the gripping power needed for structural location in a compact region as opposed to over the full length of the internal channel 7. This bulk also supports the rectangular shape of the leading opening 4, which conforms to the profile of most frame arms, and prevents the hooks from rotating on said arms.

What is claimed is:

1) An eyeglass retainer device for attaching to eyeglass frame arms, comprising
a) A soft silicone molded hook-shaped retainer, and
b) An elastic molded compression band for compressing said retainer onto said frame arm

2) The eyeglass retainer device of claim 1 where the materials shall be an elastomeric moldable material

3) The eyeglass retainer device of claim 1 where the top opening of the attachment slot is rectangular

4) The eyeglass retainer device of claim 1 where the top rectangular opening is a frame of greater diameters than the body of the rest of the mounting slot

5) The eyeglass retainer device of claim 1 where the mid-section of the mounting slot shall include voids for compression and gripping of the frame arms

6) The mounting slot area in claim 5 where the side walls shall have concave inward shapes

7) The eyeglass retainer device of claim 1 where the compression band fits over the voids of claim 5 and walls of claim 6

8) The eyeglass retainer device of claim 1 where the bottom opening of the attachment slot is rectangular
